(19) United States
(12) Patent Application Publication
(10) Pub. No.: US 2006/0290022 A1
(43) Pub. Date: Dec. 28, 2006

(54) Self contained multipurpose monolithic structural body

(76) Inventor: Thad Paul Sundrla, Rose Township, MI (US)

Correspondence Address: Thad Sundrla, 6854 Big Trail, Holly, MI, 48442, US

(21) Appl. No.: 11/158,216

(22) Filed: Jun. 22, 2005

(51) Int. Cl. B29C 41/24

(52) U.S. Cl. 264/165

(57) ABSTRACT

The present invention involves the creation of a self contained multipurpose monolithic structural body. The invention eliminates the need for the use of multiple pieces in the manufacture of vehicles, automobiles, aircraft, spacecraft, engines, homes and other items of manufacture, thereby causing the entire item of manufacture to be one unit. The viscus of the unit contains conduits through which necessary wiring, mechanical parts, fuel, coolant, air, gases and other fluids pass. The invention simplifies the current hazards associated in the manufacture of items, by eliminating the use of multiple pieces and thereby decreasing the likelihood of failure of an individual part which often leads to failure of the whole. Moreover, because the invention is monolithic and self contained, the invention reduces the cost of manufacturing items, increases structural strength and integrity and reduces the structural weight of the item manufactured.

### FIELD OF THE INVENTION

The invention relates to the manufacture of a monolithic structure. In particular the invention relates to a monolithic structure which is a complete unit in and of itself, thereby eliminating the need for multiple parts.

### BACKGROUND OF THE INVENTION

Current structures contain multiple parts which are often welded or bolted together, thereby increasing the potential for failure of a particular piece which often leads to the failure of the whole structure. Accordingly, it would be desirable to eliminate the potential for failure by the use of a monolithic structure which is comprise of a single body within which there are conduits for the placement of wiring, mechanical needs, fuel, coolant air and other liquids. Moreover, by creating a structure which is monolithic, the cost of manufacturing said item is reduced, the structural strength of the item manufactured is increased as is the integrity of the item manufactured. Finally the weight of the item manufactured is greatly reduced.

### SUMMARY OF THE INVENTION

The present invention solves the problem seen in current structures by the creation of a monolithic structure which is self supporting. This is achieved through the following steps:
(a) the creation of a mold in the shape and size of the structure to be created, or in the case of large structures, several smaller molds which are capable of interlocking with each other; and
(b) the placement of spaces or conduits within the mold, which lead to a main access panel and which are formed out of the same material as the structure is to be made, so as to create passages through which wires, mechanical parts, fuel, air, coolant and other liquids necessary for the operation of the structure can be placed once the structure has been molded; and
(c) the pouring of the appropriate material out of which the structure is to be made, such as plastic, aluminum or other metal;
(d) allowing the cooling of the molded material after which the mold is removed and the structure is ready for the placement of any necessary wiring, mechanical parts, fuel, air coolant or other necessary liquids into the structure.

The present invention has unlimited usefulness and applicability. The present invention may be used in the manufacture of vehicles such as automobiles, aircraft and space craft. The invention may also be used in the manufacture of engines, homes or other buildings.

### BRIEF DESCRIPTION OF THE DRAWINGS

FIG. 1 is a perspective view of a the final molded structure such as that which would be used in the manufacture of a building or other item of manufacture using a square mold. The view shows the conduits through which wiring and desired heating, cooling or other liquids would be placed.

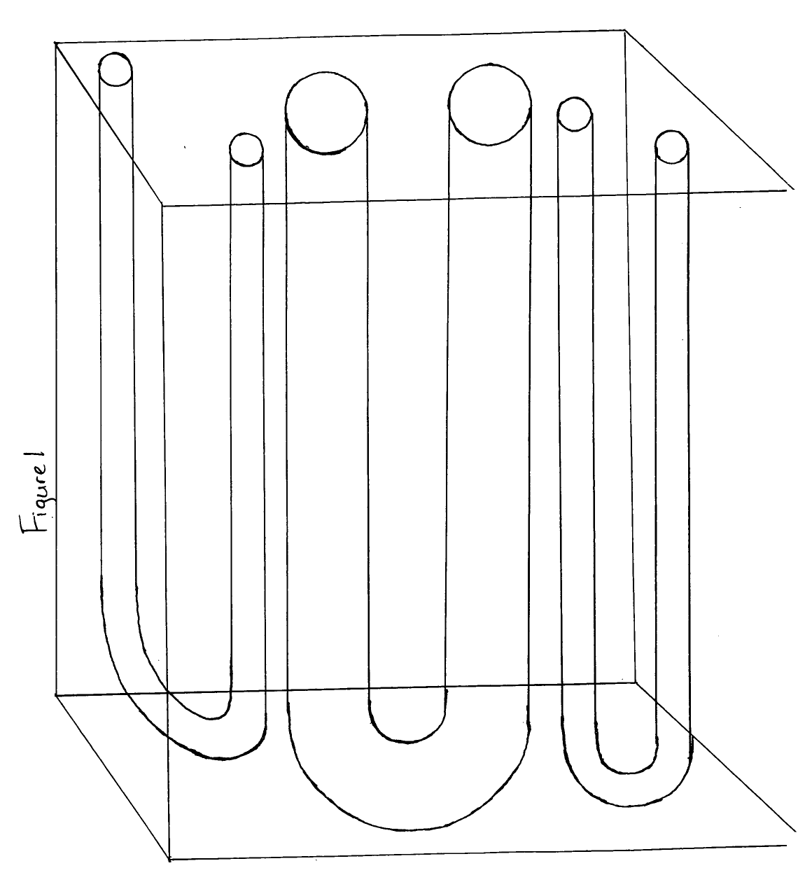

FIG. 2 is a perspective view of a final molded structure that is circular or oblong in nature. The view shows how the various conduits would be placed for wiring and other liquids.

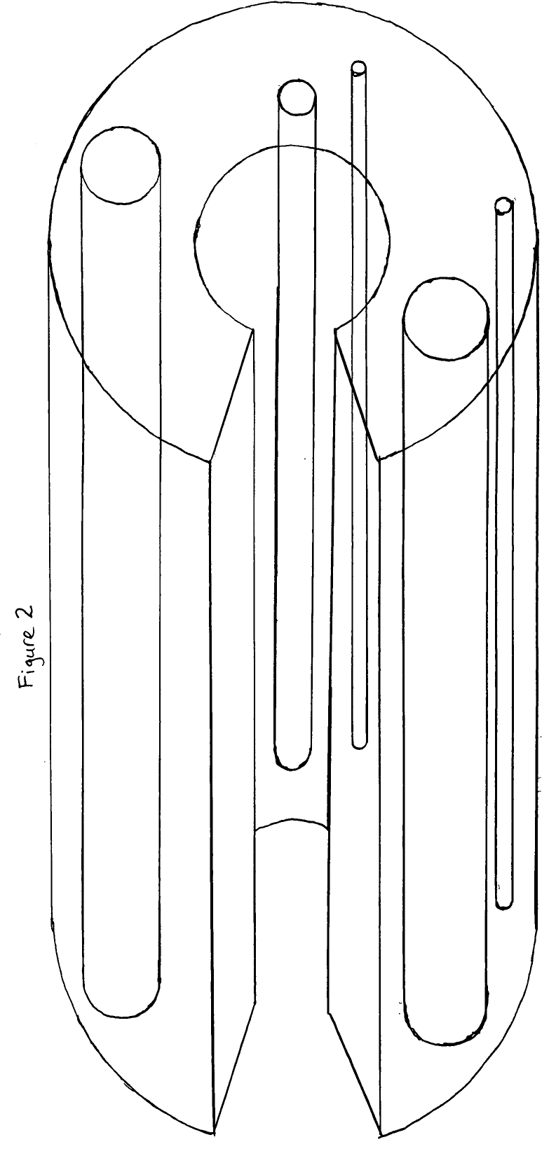

### DETAILED DESCRIPTION OF INVENTION

This invention has unlimited application to almost any item of manufacture, including but not limited to vehicles, automobiles, aircraft, spacecraft, engines, homes and other items of manufacture.

The creation of a mold in the shape and size of the item desired to be manufactured is the first step in this process and in the case of large structures, several interlocking molds would need to be made. The mold once made is reusable, except for the conduits, thereby reducing the manufacturing costs of the product. By creating a molded unit, the item produced likewise is self contained thereby eliminating the need for smaller parts such as bolts, nuts and the like. The elimination of these smaller parts will lead to an overall greater structural integrity and strength of the item manufactured, not to mention the reduction in weight of the item produced.

Once the mold is made, conduits, which lead to a main access panel, are placed between the inner “body” and outer “skin” of the mold. The conduits are intended to be made of the same material from which the mold is to be cast thereby causing the conduits to become part of the final structure. By placing the conduits between the “body and skin” of the item to be manufactured, the item of manufacture will become self contained. Moreover, the structure will be able to be heated and cooled through these conduits thereby creating a more efficient and thereby less expensive method of heating and cooling the item of manufacture.

Once the conduits are placed within the molded structure, the mold is poured with any light weight durable material desired by the manufacturer. The mold is then allowed to cool or cure and once cooled or cured, the mold is removed from the item of manufacture. Necessary wiring, coolant and other liquids and gases needed in the operation or use of the structure are then placed within the structure either at the point of manufacture, or in the case of buildings at the point of construction.

Turning attention to figure one, this is intended to be an example of what a molded wall for use in a building might look like. The conduits can be clearly seen within the structure itself. The conduits, with access panels, can be used for the placement of wires, cooling and heating liquids, gas, waste lines, cable lines and water. The placement of heating and cooling within the structure itself will enable the building to be heated and cooled more efficiently and therefore more economically. Moreover, the conduits would afford more protection to the items placed within them leading to a longer and more effective use of the items. Finally, the need for smaller parts to connect the various pieces of the building are eliminated, thereby creating a more structurally sound building.

Turning attention to figure two, this is intended to show the unlimited design applicability this invention has. The invention need not be limited to one size or shape, but can be used to create any item desired by the manufacturer. Again one can see the conduits through which wiring and liquids can be placed, leading to more efficiency.

1) A method of manufacturing a self contained multipurpose monolithic structural body comprised of:
(a) molding of the structure encompassing what is commonly referred to as the “skin and body” frame of a structure, or in the case of large structures, several smaller molds which are capable of interlocking with each other; and
(b) within or between the “skin and body” of the molded structure conduits for the placement of wiring, mechanical needs of the structure, fuel, coolant air and other liquids which conduits are to be made of the same material from which the structure is to be made and which therefore become a part of the molded structure.
